(19) United States
(12) Patent Application Publication
(10) Pub. No.: US 2024/0103705 A1
(43) Pub. Date: Mar. 28, 2024

(54) Convergence During 3D Gesture-Based User Interface Element Movement

(71) Applicant: Apple Inc., Cupertino, CA (US)

(72) Inventors: Vinay Chawda, Santa Clara, CA (US); Julian K. Shutzberg, San Francisco, CA (US); Chase B. Lortie, San Francisco, CA (US); Daniel J. Brewer, San Jose, CA (US); David J. Meyer, Menlo Park, CA (US); Leah M. Gum, Sunol, CA (US)

(21) Appl. No.: 18/367,036

(22) Filed: Sep. 12, 2023

Related U.S. Application Data
(60) Provisional application No. 63/409,281, filed on Sep. 23, 2022.

(51) Int. Cl. G06F 3/04847; G06F 3/01; G06F 3/04815

(52) U.S. Cl. CPC G06F 3/04847; G06F 3/011; G06F 3/017; G06F 3/04815

(57) ABSTRACT

Various implementations disclosed herein facilitate interactions with a user interface in 3D environment in which a user interface element is moved based on a user movement in a way that the user interface element appears to lag behind or follow a portion of the user (e.g., the user's fingertip). The user interface element may be moved in a way that it converges with and thus catches up to the portion of the user. Such convergence may be based on the speed of the movement of the portion of the user. No convergence may occur when the portion of the user is not moving or is moving below a threshold speed. When the portion of the user is moving (e.g., above a threshold speed), the user interface component may converge with the portion of the user and the rate of convergence may be increased with faster speeds.

### CROSS-REFERENCE TO RELATED APPLICATIONS

This application claims the benefit of U.S. Provisional Application Ser. No. 63/409,281 filed Sep. 23, 2022, which is incorporated herein in its entirety.

### TECHNICAL FIELD

The present disclosure generally relates to assessing user interactions with electronic devices that involve hand and body gestures.

### BACKGROUND

Existing user interaction systems may be improved with respect to facilitating interactions based on user hand and body gestures and other activities.

### SUMMARY

Various implementations disclosed herein include devices, systems, and methods that display and facilitate interactions with a user interface in a 3D environment (e.g., an XR environment) in which a user interface element is moved based on a user movement. For example, the user interface may move a scroll bar handle or a slider based on a movement of a portion of the user, e.g., where the user positions their fingertip on or through the handle or slider in the 3D environment and moves the finger in a direction to cause a corresponding movement of the handle or slider. In some cases, the system may be able to respond quickly enough to move the user interface element along with the portion of the user, e.g., with the fingertip appearing to be on or through the user interface element through the entire path of motion. However, in other cases, there may be a delay in recognizing the user movement, determining how to response to the user movement, or otherwise in moving the user interface element in response to the user movement. Thus, responding to the movement of the portion of the user may require presented user interface element in a way that the user interface element appears to lag behind or follow the portion of the user in the user's view.

Implementations disclosed herein adjust the movement of the user interface element to converge with and thus catch up to the portion of the user. Such convergence may be based on the speed of the portion of the user (e.g., fingertip). No convergence may occur when the portion of the user is not moving or is moving below a threshold speed. When the portion of the user is moving (e.g., above a threshold speed), the user interface component may converge with the portion of the user, and the rate of convergence may increase with faster speeds. The user may be less likely to notice or object to convergence while the portion of the user is moving, e.g., while moving their hand. The convergence may be more in-line with the user's expectation that the user interface element only moves while the portion of the user is moving. The user may not expect to see the user interface element moving when the portion of the user is still. Implementations disclosed herein provide convergence that may be more consistent with these or other user expectations regarding user interface behavior.

In some implementations, a processor performs a method by executing instructions stored on a computer readable medium. The method displays an extended reality (XR) environment corresponding to a three-dimensional (3D) environment. The XR environment depicts a portion of a user (e.g., a fingertip, hand, or other portion of the user) and a user interface comprising a user interface element (e.g., a scroll bar, slider, button, icon, text, menu item, graphical item, etc.). The user interface may be displayed at a fixed position or otherwise within the XR environment, e.g., as a virtual 2D menu with user interface content and elements displayed a few feet in front of the user in XR.

The method tracks a movement of the portion of the user, e.g., tracking the user's hands, fingers, etc. In one example, this involves tracking a position and configuration of a user's hand within a physical environment and applying that positioning and configuration within a corresponding XR environment. For example, the positions of the user's hand and/or fingertip may be tracked relative to the 3D positions of a user interface and its elements within the XR environment. Tracking the movement of the portion of user may identify when a portion of the user touches, passes through, taps, or otherwise interacts with a user interface element. Tracking the movement of the portion of the user may identify a movement path of the portion of the user, for example, identifying that the user's hand or fingertip has moved along a path in a particular direction (e.g., left) within the physical environment, the XR environment, or relative to the user interface. Tracking the movement of the portion of the user may involve determining a speed of the portion of the user, e.g., tracking the instantaneous velocity or average velocity during one or more time segments.

The method determines a convergence rate based on the movement of the portion the user. For example, the convergence rate may be based on whether the portion of the user is currently moving or not. In another example, the convergence rate is determined based a current speed of the movement. In some implementations, the method determines a zero convergence rate when the portion of the user is not moving, a relatively slow convergence rate when the portion of the user is moving relatively slowly, and a relatively fast convergence rate when the portion of the user is moving relatively quickly.

The method moves the user interface element based on the movement of the portion of the user, where the user interface element converges with the portion of the user in the XR environment based on the convergence rate. The method may involve updating views of the XR environment to display movements of the user interface element and those updates may be based on repositioning the user interface element over time in a way that the user interface element appears to converge with the portion of the user. For example, if the user interface element is lagging behind the user's fingertip, the distance separating the user interface element and fingertip in the view of the XR environment may be reduced over time until the user interface element has caught up to (e.g., is collocated with, touching, etc.) the fingertip. Determining the convergence rate of such a convergence based on the movement of the portion of the user may provide a user experience that is more realistic or that is otherwise in-line with user expectations, e.g., providing a user experience that is preferable to one that uses a fixed or constant convergence rate that does not vary based on the movement of the portion of the user.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment in accordance with some implementations.

FIG. 2 illustrates views of an XR environment provided by the device of FIG. 1 based on the physical environment of FIG. 1 in which a user interface element lags behind a portion of a user during movement of the portion of the user, in accordance with some implementations.

FIGS. 3-5 illustrate moving the user interface element of FIG. 2 to converge with the portion of the user based on the movement of the portion of the user in accordance with some implementations.

FIG. 6 is a flowchart illustrating a method for moving a user interface element based on a movement of a portion of a user, in accordance with some implementations.

FIG. 7 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

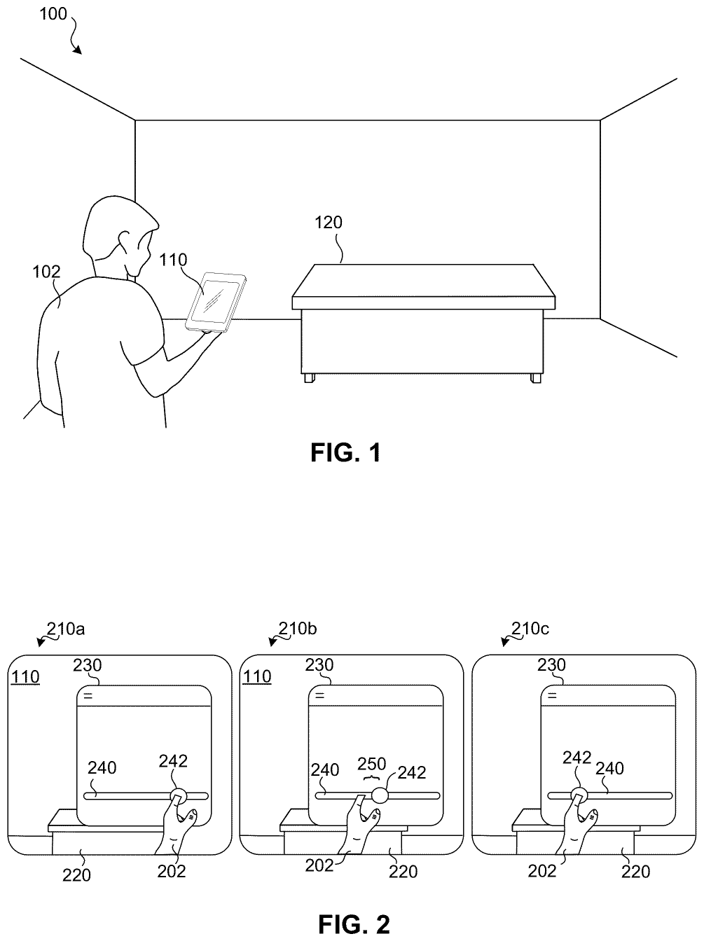

FIG. 1 illustrates an exemplary electronic device 110 operating in a physical environment 100. In this example of FIG. 1, the physical environment 100 is a room that includes a desk 120. The electronic device 110 includes one or more cameras, microphones, depth sensors, or other sensors that can be used to capture information about and evaluate the physical environment 100 and the objects within it, as well as information about the user 102 of the electronic device 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

FIG. 2 illustrates views of an XR environment provided by the device 110 based on the physical environment 100 in which a user interface element lags behind a portion of a user 202 during movement of the portion of the user 202. The views 210a-c of the XR environment include an exemplary user interface 230 of an application (i.e., virtual content) and a depiction 220 of the table 120 (i.e., real content). Providing such a view may involve determining 3D attributes of the physical environment 100 and positioning the virtual content, e.g., user interface 230, in a 3D coordinate system corresponding to that physical environment 100.

In the example of FIG. 2, the user interface 230 may include various content and user interface elements, including a scroll bar shaft 240 and its scroll bar handle 242 (also known as a scroll bar thumb). Interactions with the scroll bar handle 242 may be used by the user 202 to provide input to which the user interface 230 respond, e.g., by scrolling displayed content or otherwise. The user interface 230 may be flat (e.g., planar or curved planar without depth). Displaying the user interface as a flat surface may provide various advantages. Doing so may provide an easy to understand or otherwise use portion of an XR environment for accessing the user interface of the application.

The user interface 230 may be a user interface of an application, as illustrated in this example. The user interface 230 is simplified for purposes of illustration and user interfaces in practice may include any degree of complexity, any number of user interface elements, and/or combinations of 2D and/or 3D content. The user interface 230 may be provided by operating systems and/or applications of various types including, but not limited to, messaging applications, web browser applications, content viewing applications, content creation and editing applications, or any other applications that can display, present, or otherwise use visual and/or audio content.

In some implementations, multiple user interfaces (e.g., corresponding to multiple, different applications) are presented sequentially and/or simultaneously within an XR environment using one or more flat background portions. In some implementations, the positions and/or orientations of such one or more user interfaces may be determined to facilitate visibility and/or use. The one or more user interfaces may be at fixed positions and orientations within the 3D environment. In such cases, user movements would not affect the position or orientation of the user interfaces within the 3D environment.

In other implementations, the one or more user interfaces may be body-locked content, e.g., having a distance and orientation offset relative to a portion of the user's body (e.g., their torso). For example, the body-locked content of a user interface could be 2 meters away and 45 degrees to the left of the user's torso's forward-facing vector. If the user's head turns while the torso remains static, a body-locked user interface would appear to remain stationary in the 3D environment at 2 m away and 45 degrees to the left of the torso's front facing vector. However, if the user does rotate their torso (e.g., by spinning around in their chair), the body-locked user interface would follow the torso rotation and be repositioned within the 3D environment such that it is still 2 m away and 45 degrees to the left of their torso's new forward-facing vector.

In other implementations, user interface content is defined at a specific distance from the user with the orientation relative to the user remaining static (e.g., if initially displayed in a cardinal direction, it will remain in that cardinal direction regardless of any head or body movement). In this example, the orientation of the body-locked content would not be referenced to any part of the user's body. In this different implementation, the body-locked user interface would not reposition itself in accordance with the torso rotation. For example, body-locked user interface may be defined to be 2 m away and, based on the direction the user is currently facing, may be initially displayed north of the user. If the user rotates their torso 180 degrees to face south, the body-locked user interface would remain 2 m away to the north of the user, which is now directly behind the user.

A body-locked user interface could also be configured to always remain gravity or horizon aligned, such that head and/or body changes in the roll orientation would not cause the body-locked user interface to move within the 3D environment. Translational movement would cause the body-locked content to be repositioned within the 3D environment in order to maintain the distance offset.

In the example of FIG. 2, at a first instant in time corresponding to view 210a, the user 102 has positioned their hand in the physical environment 100 and a corresponding depiction 202 of the user 102 shows a fingertip of the user 102 touching or extending into a scroll bar handle 242. The device 110 may track user positioning, e.g., locations of the user's fingers, hands, arms, etc. The device 110 may determine positioning of the user relative to the user interface 230 (e.g., within an XR environment) and identify user interactions with the user interface based on the positional relationships between them. In this example, the device 110 detects that the depiction 202 of the user 102 is in contact with or co-located with the scroll bar handle 242 and initiates the start of a user interaction accordingly. For example, the device 110 may start tracking the user's subsequent movement for the purpose of displaying a corresponding movement of the scroll bar handle 242, e.g., so that the scroll bar handle 242 will move along or otherwise based on the left/right movement of the depiction 202 of the portion of the user 102 that contacts or intersects the scroll bar handle 242. Movement of the scroll bar handle 242 (caused by such user motion) may also trigger a corresponding user interface response, e.g., causing the user interface 230 to scroll displayed content according to the amount the scroll bar handle 242 is moved, etc.

In some cases, the device 110 may be able to respond quickly enough to move the scroll bar handle 242 along with the depiction 202 of the portion of the user 102, e.g., with the fingertip appearing to be on or through the scroll bar handle 242 through some or all of a path of motion of the portion of the user 102. However, in other cases, there may be a delay in moving the scroll bar handle. During the movement of the scroll bar handle 242, responding to the movement of the portion of the user 201 may require presented scroll bar handle 242 in a way that it appears to lag behind or follow the depiction 202 of the portion of the user 102.

Thus, in the example of FIG. 2, at a second instant in time corresponding to view 210b, the user 102 has moved their hand in the physical environment 100 and a corresponding depiction 202 of the user 102 has moved left with respect to the user interface 230. Movement of the scroll bar handle 242 is triggered by this movement of the portion of the user 102. However, the display of the movement of the scroll bar handle 242 is delayed and lags behind the depiction 202 of the portion of the user 202 by a distance 250. Such delay or lag may occur in various circumstances. For example, such delay or lag may occur if the depiction 202 of the user 102 is provided in real-time with the user's movement (e.g., via pass-through or see through video provided without delay) while the user interface 230 is updated and displayed after a delay required to obtained sensor data, process user activity, and/or adjust the user interface 230 content in response to that user activity.

Implementations disclosed herein adjust the movement of the user interface element, e.g., scroll bar handle 242, to converge with and thus catch up to a portion of the user (e.g., to depiction 202 of a portion of the user 102). In the example of FIG. 2, at a third instant in time corresponding to view 210c, the user 102 has continued moving their hand in the physical environment 100 and the corresponding depiction 202 of the user 102 has continued moving left with respect to the user interface 230. The scroll bar handle 242 has converged (e.g., caught up to) the depiction 202 of the portion of the user 102 and now appears at the same position, e.g., the depiction 202 of the portion of the user 102 and the scroll bar handle 242 appear to be touching/intersecting in the view of the XR environment.

Such convergence may occur over time during the movement of the depiction 202 of the portion of the user 102 such that the distance 250 decreases over time, e.g., the gap between the scroll bar handle 242 and depiction 202 of the portion of the user decreasing gradually or over a series of multiple frames. The convergence may occur at a convergence rate, e.g., the rate at which the distance 250 decreases over time. The convergence rate itself may be modified or change over time during the movement of the portion of the user 102.

The convergence may be based on the speed of the portion of the user 102 (e.g., fingertip). No convergence may occur when the portion of the user 102 is not moving or is moving below a threshold speed. When the portion of the user 102 is moving (e.g., above a threshold speed), the user interface element may converge with the portion of the user 102 and the rate of convergence vary based on movement speed, e.g., providing a relatively greater convergence for relatively faster hand movement speeds.

In some cases, the portion of the user may change direction and/or speed during the course of a movement. For example, at the point in time corresponding to view 210b, the depiction 202 of the portion of the user 202 could change direction and move to the right back towards scroll bar handle 242. Such a change in direction and/or the associated speed may be used to determine the convergence, e.g., the convergence rate may be reduced based on the direction of movement being back towards the associated scroll bar handle 242. In another example, at the point in time corresponding to view 210b, the depiction 202 of the portion of the user 202 could change direction and retract towards the user away from the user interface 230. In some implementations, this directional change and/or the direction of new movement may also be used to determine the convergence rate. For example, based on determining that the depiction 202 of the portion of the user 202 is retracting towards a head or torso of the user 102, the convergence rate may be increased or decreased. In one example, the convergence rate is increased to a max rate such that the scroll bar handle appears to jump right to the point at which the depiction 202 of the user 102 breaks contact with the user interface 202. In some implementations, convergence rate is determined based upon direction of movement, speed of movement, and/or other characteristics of the motions indicative of a user expectation regarding user interface response, e.g., how the user expects the user interface to act based on the characteristics of their motion.

Basing the convergence on the speed or other attributes of the motion of the portion of the user 102 may provide various benefits. The user 102 may be less likely to notice or object to convergence while the portion of the user 102 is moving. The convergence may be more in-line with the user's expectation that the user interface element (e.g., scroll bar handle 242) should only move while the portion of the user 102 is moving. The user 102 may not expect to see the user interface element (e.g., scroll bar handle 242) moving when the portion of the user 102 is still.

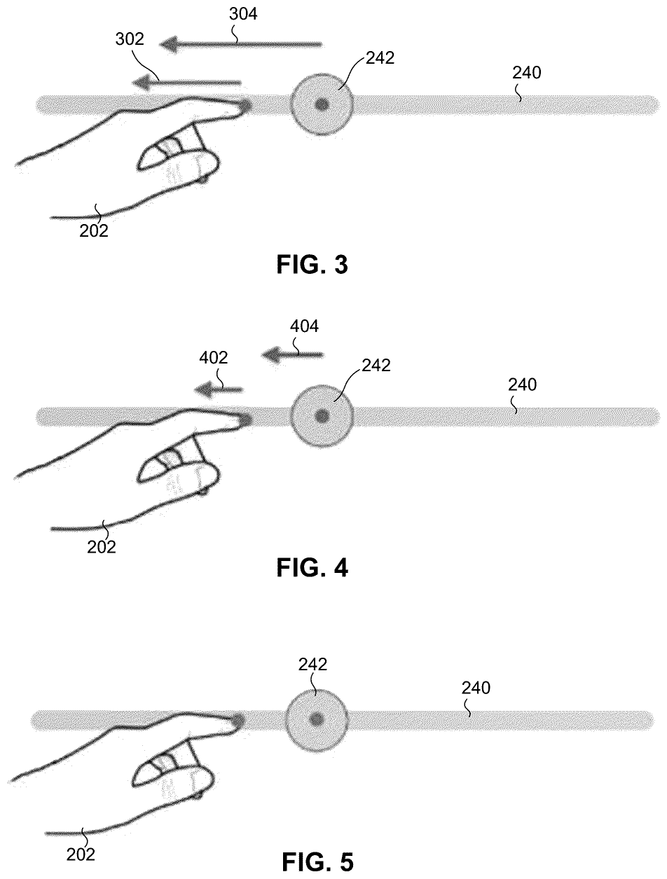

FIGS. 3-5 illustrate moving the user interface element of FIG. 2 to converge with the portion of the user 102 based on the movement of the portion of the user 102.

FIG. 3 illustrates the scroll bar handle 242 lagging behind the depiction 202 of portion of the user 102 along the depiction 240 of the scroll bar shaft 140. As indicated by the speed indicator graphic 302, the depiction 202 of the portion of the user 102 (and thus the portion of the user 102 itself) is moving at a relatively fast speed. Based on this relatively fast speed of the movement of the depiction 202 of the portion of the user 102 (and of thus the portion of the user 102 itself), a relatively fast convergence rate (as indicated by convergence rate graphic 304) is determined to be applied to move the scroll bar handle 242 to converge/catch up with the depiction 202 of the portion of the user 102.

FIG. 4 similarly illustrates the scroll bar handle 242 lagging behind the depiction 202 of portion of the user 102 along the depiction 240 of scroll bar shaft 140. As indicated by the speed indicator graphic 402, the depiction 202 of the portion of the user 102 (and thus the portion of the user 102 itself) is moving at a relatively slow speed. Based on this relatively slow speed of the movement of the depiction 202 of the portion of the user 102 (and thus of the portion of the user 102 itself), a relatively slow convergence rate (as indicated by convergence rate graphic 404) is determined to be applied to move the scroll bar handle 242 to converge/catch up with the depiction 202 of the portion of the user 102.

FIG. 5 similarly illustrates the scroll bar handle 242 lagging behind the depiction 202 of portion of the user 102 along the depiction 240 of scroll bar shaft 140. The depiction 202 of the portion of the user 102 (and thus the portion of the user 102 itself) is not moving, i.e., movement speed is equal to zero or less than a threshold value. Based on this lack of movement of the depiction 202 of the user 102 (and thus of the user 102 itself), a zero convergence rate is determined to be applied to move the scroll bar handle 242 to converge/catch up with the depiction 202 of the portion of the user 102. In some implementations, a very slow convergence rate (e.g., an imperceptibly slow rate) is used when then portion of the user 102 is still or concluded moving (e.g., no longer contacting any portion of the user interface 230).

In other implementations, convergence may additionally or alternatively be based on distance between the portion of the user and the user interface element. For example, if there is a relatively large distance between the depiction 202 of the user 102 and the scroll bar handle 242 there may be a greater convergence rate than if there is a relatively small distance between the depiction 202 of the user 102 and the scroll bar handle 242. In some implementations, convergence rate is based on speed and distance, e.g., convergence rate is high even though the speed is low when the distance is large and vice versa.

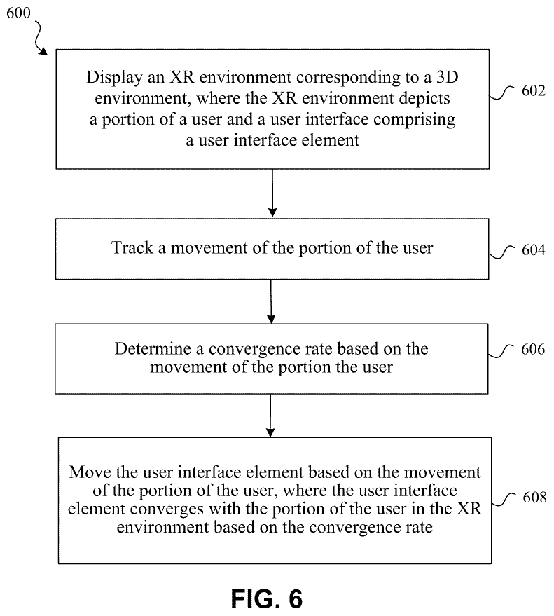

FIG. 6 is a flowchart illustrating a method 600 for moving a user interface element based on a movement of a portion of a user. In some implementations, a device such as electronic device 110 performs method 600. In some implementations, method 1100 is performed on a mobile device, desktop, laptop, HMD, or server device. The method 600 is performed by processing logic, including hardware, firmware, software, or a combination thereof. In some implementations, the method 600 is performed on a processor executing code stored in a non-transitory computer-readable medium (e.g., a memory).

At block 602, the method 600 displays an XR environment corresponding to a 3D environment, where the XR environment depicts a portion of a user (e.g., a fingertip, hand, or other portion of the user) and a user interface comprising a user interface element (e.g., a scroll bar, slider, button, icon, text, menu item, graphical item, etc.). The user interface may be displayed at a fixed position or otherwise within the XR environment, e.g., a virtual 2D menu with user interface content and elements displayed a few feet in front of the user in XR.

At block 604, the method 600 tracks a movement of the portion of the user. In one example, tracking the movement of the portion of the user involves tracking a position and configuration of a user's hand within a physical environment and applying that positioning and configuration within a corresponding XR environment. For example, the positions of the user's hand or fingertip may be tracked relative to the 3D positions of a user interface and its elements within the XR environment. Tracking the movement of the portion of the user may involve tracking the movement of the user along a 2D or 3D path.

In some implementations, the portion of the user corresponds to a point on or in a finger of the user. The portion of the user may correspond to a point on or in a hand of the user. The user position data may correspond to a position within a skeleton representation of the user that is generated periodically, e.g., at multiple points in time during a period of time.

Tracking the movement of the portion of user may identify when a portion of the user touches, passes through, taps, or otherwise interacts with a user interface element. Tracking the movement of the portion of the user may identify a movement path of the portion of the user, for example, identifying that the user's hand or fingertip has moved along a path in a particular direction (e.g., left) within the XR environment.

Tracking the movement of the portion of the user may involve determining a speed/velocity of the portion of the user, e.g., tracking the instantaneous velocity or average velocity over device time segments. The speed of the movement may be relative to the physical environment in which the user activity is occurring, the XR environment in which the user's activity is depicted/replicated, the user interface (e.g., the 2D velocity of the user's motion relative to the 2D surface of the user interface).

The movement of the portion of the user may vary over time. For example, the portion of the user may accelerate, decelerate, stop, move back and forth, and so forth during the course of the user moving the portion along a path or otherwise from an initial point or position to a final point or position. The speed/velocity of the portion of the user may provide a time-based signal of instantaneous speed/velocity values, speed velocity values associated with individual time segments (e.g., average speed over the last X ms), or otherwise correspond to the speed/velocity of the portion of the user at one or more times or time periods during the movement.

At block 606, the method determines a convergence rate based on the movement of the portion the user. In one example, this this involves determining a zero convergence rate when the portion of the user is not moving, determining a relatively slow convergence rate when the portion of the user is moving relatively slowly, and determining a relatively fast convergence rate when the portion of the user is moving relatively quickly. In one example, the convergence rate is proportional to a speed of the movement.

At block 608, the method moves the user interface element based on the movement of the portion of the user, where the user interface element converges with the portion of the user in the XR environment based on the convergence rate. The user interface element may be moved to follow the portion of the user and converge to catch up with the portion of the user during the movement of the portion of the user.

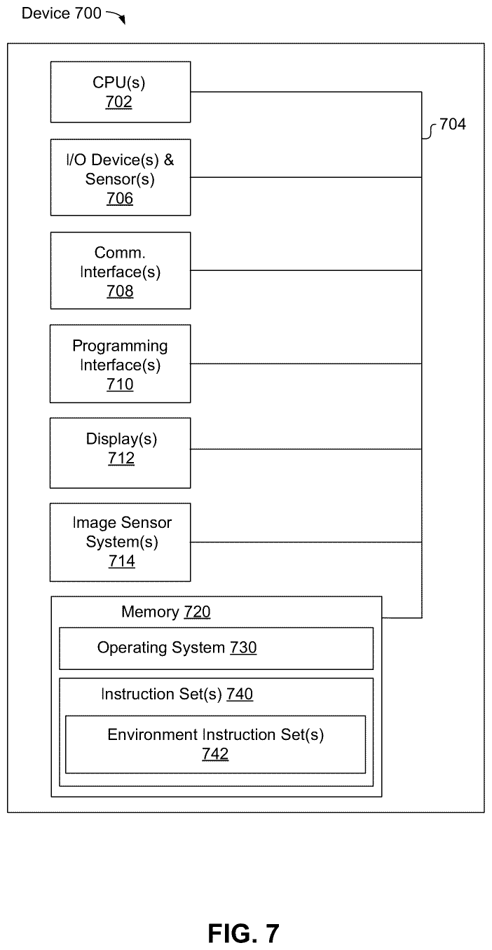

FIG. 7 is a block diagram of electronic device 700. Device 700 illustrates an exemplary device configuration for electronic device 110. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 710, one or more output device(s) 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 712 include one or more displays configured to present a view of a 3D environment to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 700 includes a single display. In another example, the device 700 includes a display for each eye of the user.

In some implementations, the one or more output device(s) 712 include one or more audio producing devices. In some implementations, the one or more output device(s) 712 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 712 may additionally or alternatively be configured to generate haptics.

In some implementations, the one or more image sensor systems 714 are configured to obtain image data that corresponds to at least a portion of a physical environment. For example, the one or more image sensor systems 714 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 comprises a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 include environment instruction set(s) 742 configured to, upon execution, identify and/or interpret provide user interface interactions within an environment as described herein. The instruction set(s) 740 may be embodied as a single software executable or multiple software executables.

Although the instruction set(s) 740 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at an electronic device having a processor:
displaying an extended reality (XR) environment corresponding to a three-dimensional (3D) environment, wherein the XR environment depicts:
a portion of a user; and
a user interface comprising a user interface element;
tracking a movement of the portion of the user;
determining a convergence rate based on the movement of the portion the user; and
moving the user interface element based on the movement of the portion of the user, wherein the user interface element converges with the portion of the user in the XR environment based on the convergence rate.

2. The method of claim 1, wherein tracking the movement of the portion of the user comprises tracking the movement along a path.

3. The method of claim 1, wherein the user interface element follows the portion of the user and converges to catch up with the portion of the user during the movement.

4. The method of claim 1, wherein determining the convergence rate comprises determining a zero convergence rate based on determining that the portion of the user is not moving.

5. The method of claim 1, wherein determining the convergence rate comprises determining a relatively slow convergence rate based on determining that the portion of the user is moving relatively slowly.

6. The method of claim 1, wherein determining the convergence rate comprises determining a relatively fast convergence rate when the portion of the user is moving relatively quickly.

7. The method of claim 1, wherein the convergence rate is proportional to a speed of the movement.

8. The method of claim 1, wherein the portion of the user is a fingertip.

9. The method of claim 1, wherein the portion of the user is a hand.

10. The method of claim 1, wherein the user interface element comprises a scroll bar or a slider on a two-dimensional user interface.

11. The method of claim 1, wherein the electronic device is a head-mounted device.

12. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
displaying an extended reality (XR) environment corresponding to a three-dimensional (3D) environment, wherein the XR environment depicts:
a portion of a user; and
a user interface comprising a user interface element;
tracking a movement of the portion of the user;
determining a convergence rate based on the movement of the portion the user; and
moving the user interface element based on the movement of the portion of the user, wherein the user interface element converges with the portion of the user in the XR environment based on the convergence rate.

13. The system of claim 12, wherein tracking the movement of the portion of the user comprises tracking the movement along a path.

14. The system of claim 12, wherein the user interface element follows the portion of the user and converges to catch up with the portion of the user during the movement.

15. The system of claim 12, wherein determining the convergence rate comprises determining a zero convergence rate based on determining that the portion of the user is not moving.

16. The system of claim 12, wherein determining the convergence rate comprises determining a relatively slow convergence rate based on determining that the portion of the user is moving relatively slowly.

17. The system of claim 12, wherein determining the convergence rate comprises determining a relatively fast convergence rate when the portion of the user is moving relatively quickly.

18. The system of claim 12, wherein the convergence rate is proportional to a speed of the movement.

19. The system of claim 12, wherein the portion of the user is a fingertip.

20. The system of claim 12, wherein the portion of the user is a hand.

21. The system of claim 12, wherein the user interface element comprises a scroll bar or a slider on a two-dimensional user interface.

22. The system of claim 12, wherein the electronic device is a head-mounted device.

23. A non-transitory computer-readable storage medium storing program instructions executable via one or more processors to perform operations comprising:
displaying an extended reality (XR) environment corresponding to a three-dimensional (3D) environment, wherein the XR environment depicts:
a portion of a user; and
a user interface comprising a user interface element;
tracking a movement of the portion of the user;
determining a convergence rate based on the movement of the portion the user; and
moving the user interface element based on the movement of the portion of the user, wherein the user interface element converges with the portion of the user in the XR environment based on the convergence rate.

24. The non-transitory computer-readable storage medium of claim 23, wherein tracking the movement of the portion of the user comprises tracking the movement along a path.

25. The non-transitory computer-readable storage medium of claim 23, wherein the user interface element follows the portion of the user and converges to catch up with the portion of the user during the movement.
